(19) United States
(12) Patent Application Publication
(10) Pub. No.: US 2014/0016013 A1
(43) Pub. Date: Jan. 16, 2014

(54) IMAGE CAPTURE METHOD

(71) Applicant: WISTRON CORP., New Taipei City (TW)

(72) Inventors: Qian Huang, New Taipei City (TW); Chun-Ming Lin, New Taipei City (TW)

(73) Assignee: WISTRON CORP., New Taipei City (TW)

(21) Appl. No.: 13/747,286

(22) Filed: Jan. 22, 2013

(30) Foreign Application Priority Data
Jul. 12, 2012 (CN) 201210242054.X

(51) Int. Cl. H04N 5/232

(52) U.S. Cl. CPC H04N 5/23293
USPC 348/333.11

(57) ABSTRACT

The present disclosure provides an image capturing method including: detecting whether a first trigger signal has been received; performing a first facial recognition process on a preview image captured by an image capture device to produce a first facial recognition result, when the first trigger signal has been received; determining whether a number of people indicated by the first facial recognition result is equal to a predetermined number of participants indicated by an input signal; and activating an output device to display a correct signal when the number of people indicated by the first facial recognition result is equal to the predetermined number of participants.

### CROSS REFERENCE TO RELATED APPLICATIONS

This Application claims priority of China Patent Application No. 201210242054.X, filed on Jul. 12, 2012, the entirety of which is incorporated by reference herein.

### BACKGROUND OF THE INVENTION

1. Field of the Invention

The present invention relates to an image capture method, and in particular, relates to an image capture method with a facial counting function.

2. Description of the Related Art

Driven by user requirements, more and more electronic devices, especially handheld or portable electronic devices such as smart phones, personal digital assists (PDAs), and tablet PCs or Ultra Mobile PCs (UMPCs), comprise various peripherals such as a video camera, for improving user convenience.

In general, most of the video cameras have face detection for capturing the faces of participants in photographs clearly. However, the video cameras may not detect all of the participants in the photographs due to the position of the participants when a large number of participants are involved, such that photograph will not be sharp and clear.

### BRIEF SUMMARY OF THE INVENTION

A detailed description is given in the following embodiments with reference to the accompanying drawings.

An embodiment of the present disclosure provides an image capturing method including detecting whether a first trigger signal has been received; performing a first facial recognition process on a preview image captured by an image capture device to produce a first facial recognition result, when the first trigger signal has been received; determining whether a number of people indicated by the first facial recognition result is equal to a predetermined number of participants indicated by an input signal; and activating an output device to display a correct signal when the number of people indicated by the first facial recognition result is equal to the predetermined number of participants.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating an embodiment of an electronic device of the present disclosure;

FIG. 2A-2B are flowcharts of an image capturing method according to an embodiment of the present disclosure; and

FIG. 3A-3B are flowcharts of an image capturing method according to another embodiment of the present disclosure.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

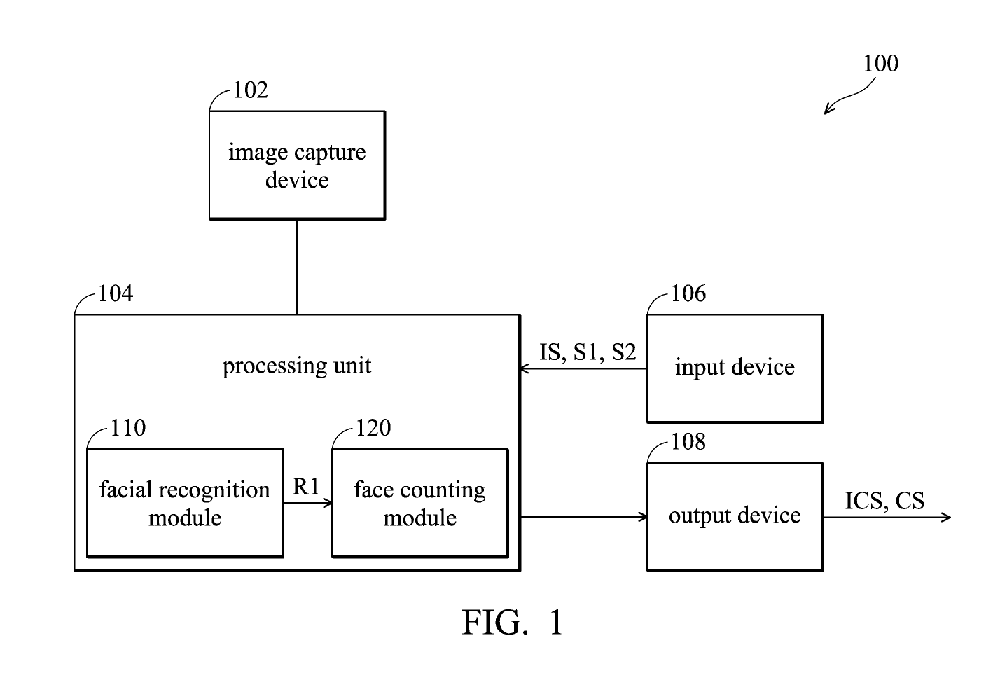

FIG. 1 is a schematic diagram illustrating an embodiment of an electronic device of the present disclosure. The electronic device 100 includes an image capture device 102, a processing unit 104, an input device 106 and an output device 108. The electronic device 100 can be implemented on various digital cameras or computer system configurations, such as smart phones, tablet computers, personal digital assistants and similar devices, but it is not limited thereto. The image capture device 102 is arranged to capture preview images and take pictures. For example, the image capture device 102 can capture preview images dynamically in real time by a lens (not shown), store the preview image in a temporary memory (not shown) for passive auto-focus, and display the preview image on a display device (not shown). Moreover, the image capture device 102 can activate the lens to take pictures according to a predetermined shutter time, aperture size, and other parameters, etc., and store the pictures in a storage device (not shown). It should be noted that the step of taking pictures in the present invention includes storing pictures in the storage device.

The processing unit 104 can further include a general purpose processor, a central-processing unit (CPU), a graphic Processing Unit (GPU), and/or a processing unit of a parallel processing environment to recognize and adjust the image taken by the image capture device 102. For example, the processing unit 104 can be arranged to recognize events or faces in the image captured by the image capture device 102, such as human faces, and adjust the color and contrast of the image captured by the image capture device 102, but it is not limited thereto.

The input device 106 is arranged to produce an input signal IS, a trigger signal S1 and a trigger signal S2 according to the inputs of users. The input signal IS represents the number of participants involved in a photograph. That is, the predetermined number of participants. The trigger signal S1 is arranged to enable a face counting process of the processing unit 104. The trigger signal S2 is arranged to enable a facial recognition process and an auto-focus function of the processing unit 104. For example, the trigger signal S2 can be the signal enabled by the shutter button of the electronic device 100. It should be noted that the input device 106 can further include at least one hardware key and/or at least one touch sensing device, but it is not limited thereto.

The output device 108 is arranged to provide a correct signal CS or an incorrect signal ICS for users according to the recognized result of the facial recognition process of the processing unit 104. In one of embodiments, the output device 108 can be a warning lamp, the correct signal CS can be green light, and the incorrect signal ICS can be red light. In another embodiment, the output device 108 can be a character string indicating a facial recognition result R1 is correct and the incorrect signal is a character string indicating the facial recognition result R1 is incorrect, but it is not limited thereto. In yet another embodiment, the incorrect signal ICS can also be the number of the faces recognized by the facial recognition process.

The processing unit 104 further includes a facial recognition module 110 and a face counting module 120. It should be noted that the processing unit 104 enable the face counting process of the face counting module 120 when the processing unit 104 receives the trigger signal S1 produced by the input device 106 according to a first input of users. In another embodiment, the processing unit 104 can enable the face counting process of the face counting module 120 when the image capture device 102 is activated. The facial recognition module 110 performs the facial recognition process on the preview image captured by the image capture device 102 when receiving the trigger signal S2 produced by the input device 106 according to a second input of users, and transmits the facial recognition result R1 to the face counting module 120. The face counting module 120 is arranged to determine whether a number of people indicated by the facial recognition result R1 is equal to the predetermined number of participants indicated by the input signal IS. For example, the faces of the participants involved in taking pictures can not be recognized when the faces is(are) hidden, turned around and/or lowered. When the number of people indicated by the facial recognition result R1 is equal to the predetermined number of participants indicated by the input signal IS, the face counting module 120 activates the output device 108 to display the correct signal CS and the image capture device 102 to take pictures. When the number of people indicated by the facial recognition result R1 is not equal to the predetermined number of participants indicated by the input signal IS, the face counting module 120 activates the output device 108 to display the incorrect signal ICS.

In some embodiments, the facial recognition module 110 produces a mark when each of the faces is recognized from the preview image captured by the image capture device 102. The face counting module 120 is arranged to count the number of the marks to obtain the number of people indicated by the facial recognition result R1 in the preview image. In some embodiments, the facial recognition module 110 and the face counting module 120 can be implemented in one module. In one of the embodiments, the facial recognition module 110 is arranged to perform the facial recognition process on the preview image captured by the image capture device 102, continuously, to produce the corresponding recognition results, and transmit the current recognition result to the face counting module 120 when receiving the trigger signal S2 produced by the input device 106 according to the second input of users.

Moreover, the electronic device 100 can further include a memory device (not shown) including a random access memory (RAM), read-only memory (ROM) and/or flash ROM. The memory device preferably stores program modules executed by the processing unit 104, such as program modules of facial recognition process and face counting process, and image captured by electronic device 100. Generally, program modules include routines, programs, objects, components, scripts, Web pages, or others, that perform particular tasks or implement particular abstract data types.

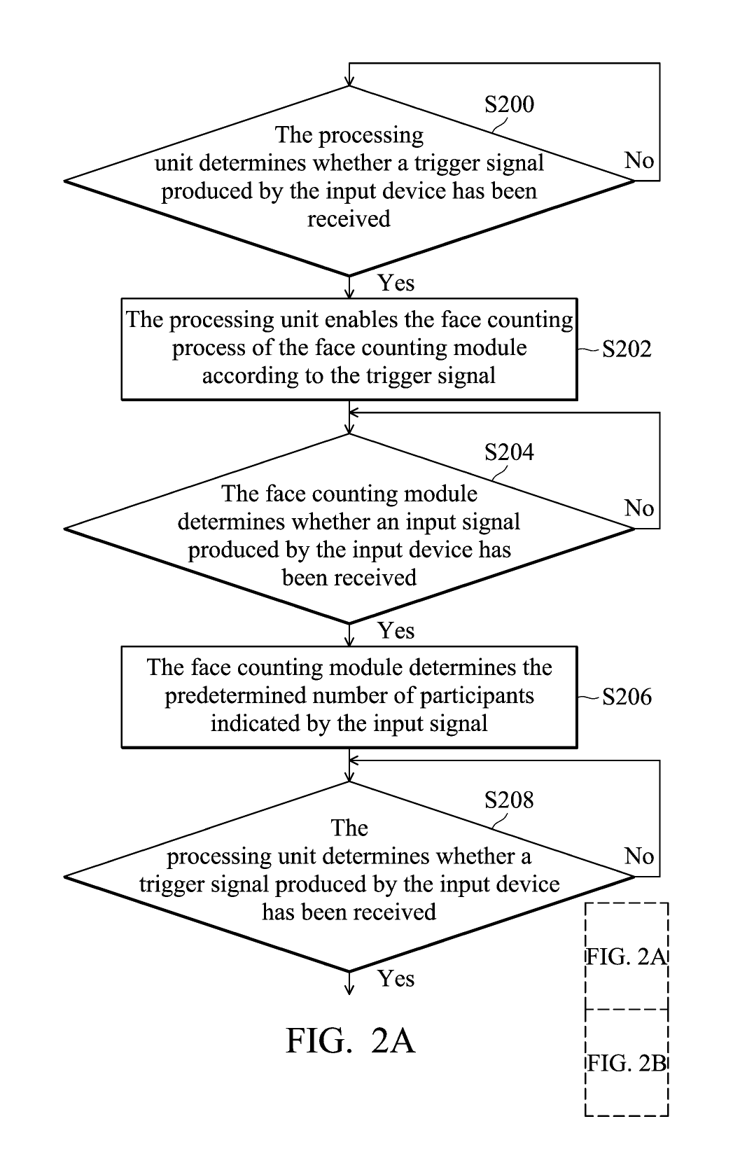

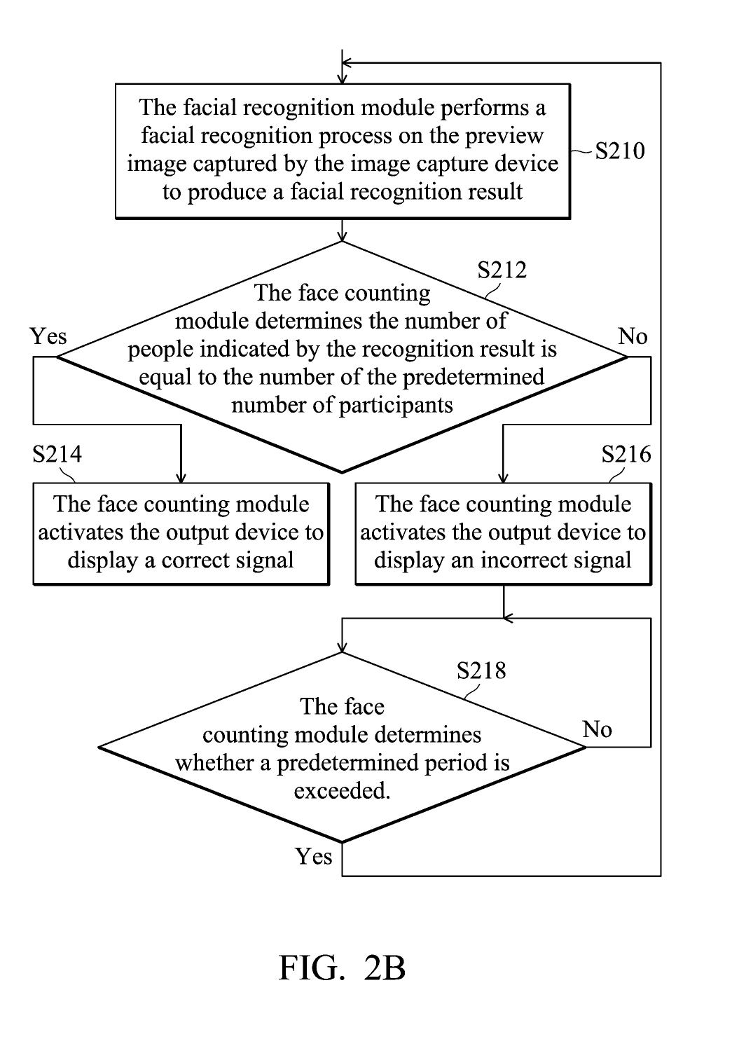

FIGS. 2A-2B are flowcharts of an image capturing method according to an embodiment of the present disclosure.

In step S200, when the image capture device 102 is enabled, the processing unit 104 determines whether a trigger signal S1 produced by the input device 106 according to a first input of users has been received. In some of embodiments, the trigger signal S1 is produced by the input device 106 and arranged to enable the face counting process of the face counting module 120. When the processing unit 104 receives the trigger signal S1 produced by the input device 106, step S202 is performed. Otherwise, the processing unit 104 continuous to determine whether the trigger signal S1 produced by the input device 106 according to the first input of users has been received.

In step S202, the processing unit 104 enables the face counting process of the face counting module 120 according to the trigger signal S1. Next, in step S204, the face counting module 120 determines whether an input signal IS produced by the input device 106 according to a third input of users has been received, for example, the input signal IS corresponding to a predetermined number of participants. When the face counting module 120 receives the input signal IS produced by the input device 106, step S206 is performed. Otherwise, the face counting module 120 continuous to determine whether an input signal IS produced by the input device 106 according to the third input of users has been received.

In step S206, the face counting module 120 determines the predetermined number of participants indicated by the input signal IS. Next, in step S208, the processing unit 104 determines whether a trigger signal S2 produced by the input device 106 according to the second input of users has been received. For example, the trigger signal S2 is arranged to enable a facial recognition process function and an auto-focus function of the processing unit 104. When the processing unit 104 receives the trigger signal S2 produced by the input device 106, step S210 is performed. Otherwise, the processing unit 104 continuous to determine whether the trigger signal S2 produced by the input device 106 according to the second input of users has been received.

In step S210, the facial recognition module 110 performs a facial recognition process on the preview image captured by the image capture device 102 to produce a facial recognition result R1. In some embodiments, the processing unit 104 activates the image capture device 102 to perform an active auto-focus on the events in front of the electronic device 100, and store the preview image in a temporary memory (not shown, such as Dynamic Random Access Memory (DRAM), such that the facial recognition module 110 can perform a facial recognition process to produce a facial recognition result R1. In another embodiment, the processing unit 104 activates the image capture device 102 to perform the auto-focus according to the preview image stored in the temporary memory when receiving the trigger signal S2 produced by the input device 106. Furthermore, the facial recognition module 110 performs a facial recognition process on to the preview image stored in the temporary memory to produce a facial recognition result R1. Next, in step S212, the face counting module 120 determines whether the number of people indicated by the facial recognition result R1 is equal to the number of the predetermined number of participants. When the number of people indicated by the facial recognition result R1 is equal to the number of the predetermined number of participants, step S214 is performed. Otherwise, step S216 is performed.

In step S214, the face counting module 120 activates the output device 108 to display a correct signal CS. Moreover, the face counting module 120 is further arranged to activate the image capture device 102 to auto-focus and take pictures according to the facial recognition result R1. For example, the image capture device 102 can take pictures according to a predetermined shutter time, aperture size, and other parameters, etc., and store the taken pictures in a storage device.

In step S216, the face counting module 120 activates the output device 108 to display an incorrect signal ICS. Next, in step S218, the face counting module 120 continuous to determine whether a predetermined period has been exceeded. When the predetermined period has been exceeded, step S210 is performed. Otherwise, the face counting module 120 continuous to determine whether the predetermined period has been exceeded. For example, when the predetermined period has been exceeded, the facial recognition module 110 performs a second facial recognition process on the preview image captured by the image capture device 102, and produces a second recognition result according to the second facial recognition process. Next, the face counting module 120 determines whether a number of people indicated by the second recognition result is equal to the predetermined number of participants. When the number of people indicated by the second recognition result is equal to the predetermined number of participants, step S214 is performed. Otherwise, step S216 is performed.

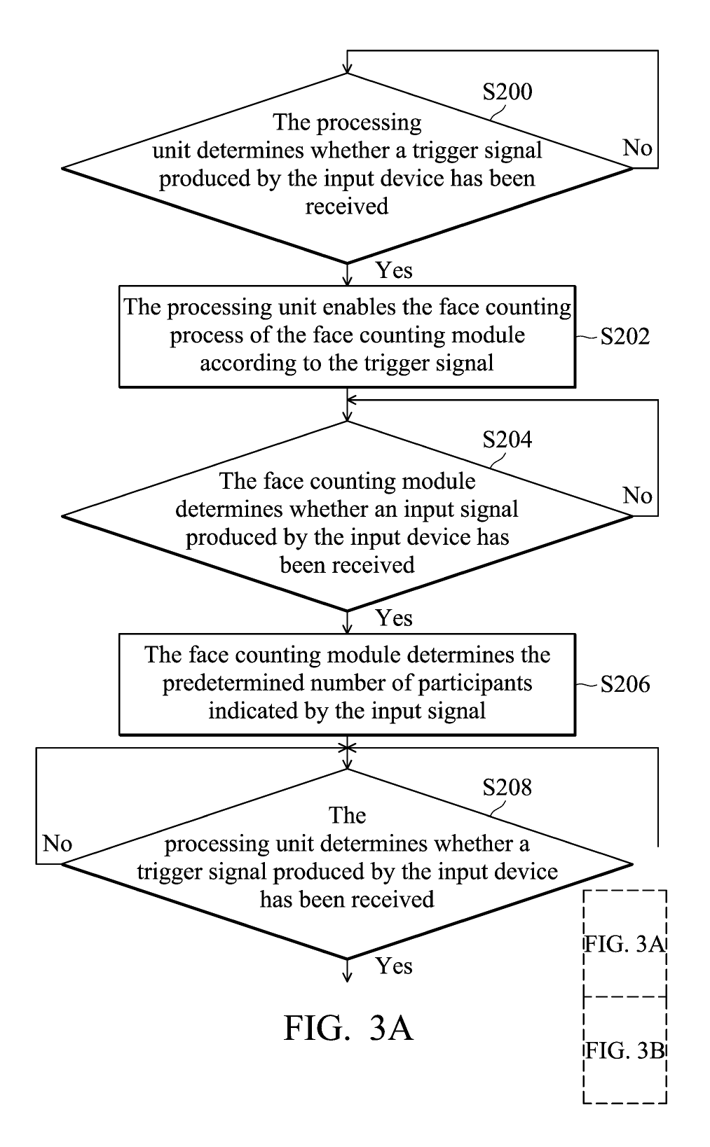

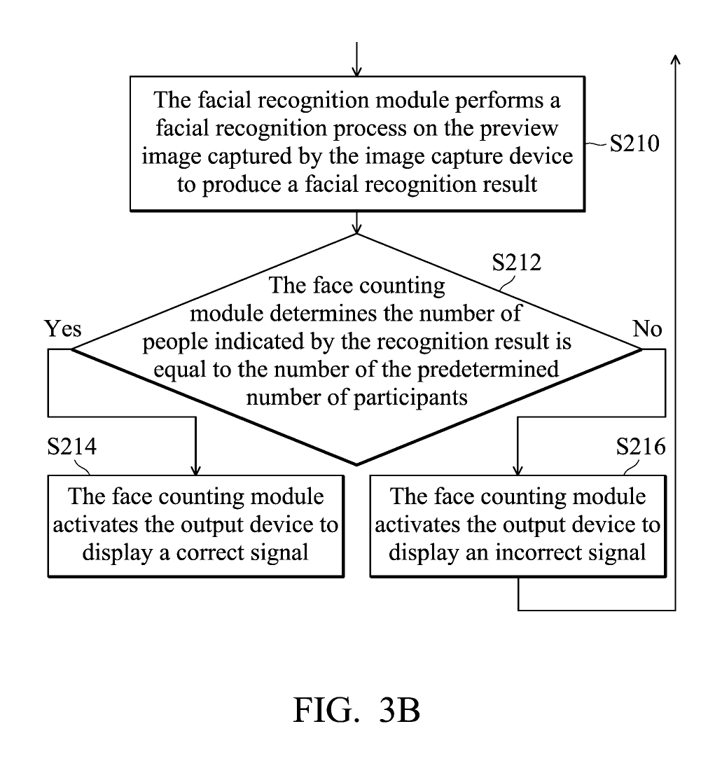

FIGS. 3A-3B are flowcharts of an image capturing method according to another embodiment of the present disclosure, wherein the image capturing method is applied to the electronic device 100 of FIG. 1. It should be noted that steps S200-S214 in FIGS. 3A-3B is similar to steps S200-S214 in FIGS. 2A-2B, but step S216 in FIGS. 3A-3B is different from step 216 in FIGS. 2A-2B. In step S216, the face counting module 120 activates the output device 108 to display an incorrect signal ICS. Next, step S208 is performed. In this embodiment, the processing unit 104 continuous to determine whether the trigger signal S2 produced by the input device 106 has been received after the face counting module 120 activating the output device 108 to display the incorrect signal ICS. The processing unit 104 enables the facial recognition process of the facial recognition module 110 again when the processing unit 104 receives the trigger signal S2. In the embodiment of FIGS. 2A-2B, the processing unit 104 determines whether a predetermined period has been exceeded after the face counting module 120 activating the output device 108 to display the incorrect signal ICS. The processing unit 104 enables the facial recognition process of the facial recognition module 110 again when the predetermined period has been exceeded. It should be noted that reference may be made to FIGS. 2A-2B for the description of steps S200-S214.

According to the image capturing method, the electronic device 100 can determine whether the predetermined number of participants inputted by users is equal to the number of the detected faces when users take pictures. Moreover, the electronic device 100 is further arranged to produce a warning signal (incorrect signal ICS) for participants to adjust their position when the predetermined number of participants entered by users is not equal to the number of the detected faces. Therefore, resulting in sharper and clearer photographs.

Data transmission methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image capturing method, comprising:
detecting whether a first trigger signal has been received;
performing a first facial recognition process on a preview image captured by an image capture device to produce a first facial recognition result, when the first trigger signal has been received;
determining whether a number of people indicated by the first facial recognition result is equal to a predetermined number of participants indicated by an input signal; and
activating an output device to display a correct signal when the number of people indicated by the first facial recognition result is equal to the predetermined number of participants.

2. The image capturing method as claimed in claim 1, further comprising activating the image capture device to take a picture when the number of people indicated by the first facial recognition result is equal to the predetermined number of participants.

3. The image capturing method as claimed in claim 2, further comprising activating the output device to display an incorrect signal when the number of people indicated by the first facial recognition result is not equal to the predetermined number of participants.

4. The image capturing method as claimed in claim 3, wherein the output device is a warning lamp, the correct signal is green light and the incorrect signal is red light.

5. The image capturing method as claimed in claim 3, wherein the correct signal is a character string indicating the first facial recognition result is correct and the incorrect signal is a character string indicating the first facial recognition result is incorrect.

6. The image capturing method as claimed in claim 3, further comprising:
determining whether a predetermined period has been exceeded when the number of people indicated by the first facial recognition result is not equal to the predetermined number of participants;
performing a second facial recognition process on another image preview image captured by the capture device to produce a second recognition result when the predetermined period has been exceeded;
determining whether a number of people indicated by the second recognition result is equal to the predetermined number of participants; and
activating the output device to display the correct signal, and activating the image capture device to take a picture when the number of people indicated by the second recognition result is equal to the predetermined number of participants.

7. The image capturing method as claimed in claim 6, further comprising activating the output device to display the incorrect signal when the number of people indicated by the second recognition result is not equal to the predetermined number of participants.

8. The image capturing method as claimed in claim 3, further comprising:
determining whether a second trigger signal has been received when the number of people indicated by the first facial recognition result is not equal to the predetermined number of participants;
performing a second facial recognition process on another preview image captured by the image capture device to produce a second recognition result when the second trigger signal has been received;
determining whether a number of people indicated by the second recognition result is equal to the predetermined number of participants; and
activating the output device to display the correct signal and activating the image capture device to take a picture, when the number of people indicated by the second recognition result is equal to the predetermined number of participants.

9. The image capturing method as claimed in claim 8, further comprising activating the output device to display the incorrect signal when the number of people indicated by the second recognition result is not equal to the predetermined number of participants.
